(19) United States
(12) Patent Application Publication
(10) Pub. No.: US 2003/0174855 A1
(43) Pub. Date: Sep. 18, 2003

(54) Speaker mounting system

(76) Inventors: Bernie Hawkins, Long Beach, CA (US); L. Paul Hales, Tustin, CA (US)

Correspondence Address: PERKINS COIE LLP, PATENT-SEA, P.O. BOX 1247, SEATTLE, WA, 98111-1247, US

(21) Appl. No.: 10/096,551

(22) Filed: Mar. 12, 2002

(51) Int. Cl. H04R 1/02

(52) U.S. Cl. 381/386; 381/394

(57) ABSTRACT

Speaker mounting systems and methods of mounting speakers are disclosed herein. One embodiment of the invention a speaker mounting system can include a mounting member attachable to a structure, a connector attachable to the mounting member, a docking member attachable to the connector, and a speaker housing releasably attached to the docking member. The speaker housing has a side with a receiving portion. The receiving portion removably receives the docking member. In another embodiment of the invention, a method for attaching a speaker housing to a structure includes mounting a mounting bracket to the structure, connecting a docking member to the mounting bracket using a connector, removably attaching a speaker housing to the docking member, and aiming the docking plate or speaker housing as a unit relative to the mounting bracket and structure.

### FIELD OF THE INVENTION

This invention relates to an audio system. More particularly, the present invention relates to a speaker mounting system.

### BACKGROUND

Audio systems are commonly used in restaurants, bars, hotels, casinos, office buildings, and other commercial establishments. In addition to commercial buildings, many residential buildings also have audio systems. As part of an audio system, speakers are often installed throughout the building. For example, speakers are sometimes installed in kitchens, offices, bathrooms, hallways, lobbies, and elevators. Frequently, multiple speakers in different areas of the building are connected via speaker wire to one or more playback or broadcasting devices (e.g., amplifier, radio, tape player, CD player). The speaker wire must be routed throughout portions of the building to connect to each of the speakers.

In buildings, speakers are often mounted to a wall or a ceiling. Mounting speakers helps prevent theft and accidents. Mounting speakers, however, can pose several difficulties. For example, sometimes speakers are installed after a wall or ceiling has been painted. In these situations there is a risk that the installation of the speaker will damage the new paint on the wall or ceiling. Alternatively, sometimes the speakers are installed before the wall or ceiling is painted. In these situations there is a chance of inadvertently getting paint on the speaker. In addition, speakers are often mounted in a location that provides a minimum amount of room around the speaker. Accordingly, connecting the speaker wire to the speaker, or accessing the wire connection on the speaker when the speaker is mounted to the wall or ceiling can be difficult.

Furthermore, the size and weight of speakers can make it difficult to fasten them to a wall, ceiling or other structure. The installation can be challenging if the speaker is big or heavy because generally the speaker will need to be held while connecting it to the speaker wire, or while connecting it to a mounting plate. Oftentimes speakers are placed high on a wall or on a ceiling, which can make installation even more difficult.

### SUMMARY

The present invention is directed to speaker mounting systems and methods of mounting speakers. In one embodiment of the invention, a speaker mounting system can include a mounting member attachable to a structure, a connector attachable to the mounting member, a docking member attachable to the connector, and a speaker housing releasably attached to the docking member. The speaker housing has a side with a receiving portion in the side. The receiving portion removably receives the docking member.

In another embodiment of the invention, a method for attaching a speaker housing to a structure includes mounting the mounting bracket to the structure, connecting the docking member to the mounting bracket using the connector, removably attaching the speaker housing to the docking member, and aiming the docking plate or speaker housing as a unit relative to the mounting bracket and structure.

### BRIEF DESCRIPTION OF THE DRAWINGS

FIG. 1 is a rear isometric view illustrating a speaker mounting system in accordance with one embodiment of the invention.

FIG. 2 is a front isometric view illustrating the speaker mounting system of FIG. 1.

FIG. 3 is a rear isometric view of the speaker mounting system of FIG. 1 shown in a docked position.

FIG. 4 is an enlarged cross-sectional side view taken substantially along line 4-4 of FIG. 3 with a latch shown in an open position.

FIG. 5 is a partial cross-sectional view similar to FIG. 4 showing the latch in a closed position.

FIG. 6 is a partial cross-sectional view taken substantially along line 6-6 of FIG. 2 illustrating a mounting plate and a docking member of one embodiment of the invention.

FIG. 7 is a side elevation view of the mounting plate and the docking member of FIG. 6.

FIG. 8 is a rear isometric view of the docking member and the mounting plate of FIG. 6 showing the mounting plate separated from the docking member.

### DETAILED DESCRIPTION

The following description is directed toward speaker mounting systems and methods for mounting speakers to a structure, such as a wall or ceiling. In the following description numerous specific details are provided, such as types of connectors, specific speaker assembly components, etc., to provide a thorough understanding of, and an enabling description for, embodiments of the invention. Those of ordinary skill in the relevant art, however, will recognize that the invention can be practiced without one or more of the specific details. For example, even though many of the embodiments of the speaker mounting system are described as having a latch and catch connection assembly, other quick connect mechanisms can also be used. In other instances, well-known structures or operations are not shown or not described in detail to avoid obscuring aspects of the invention.

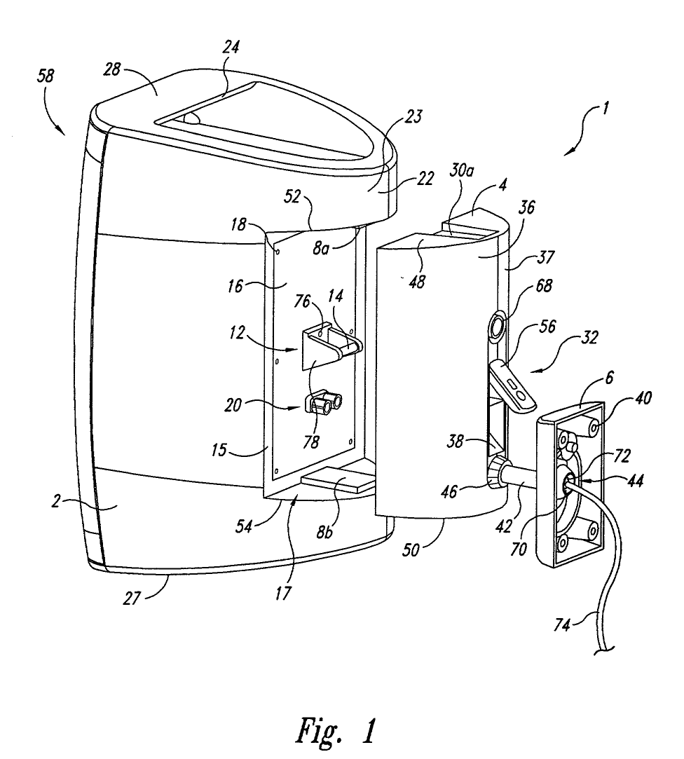

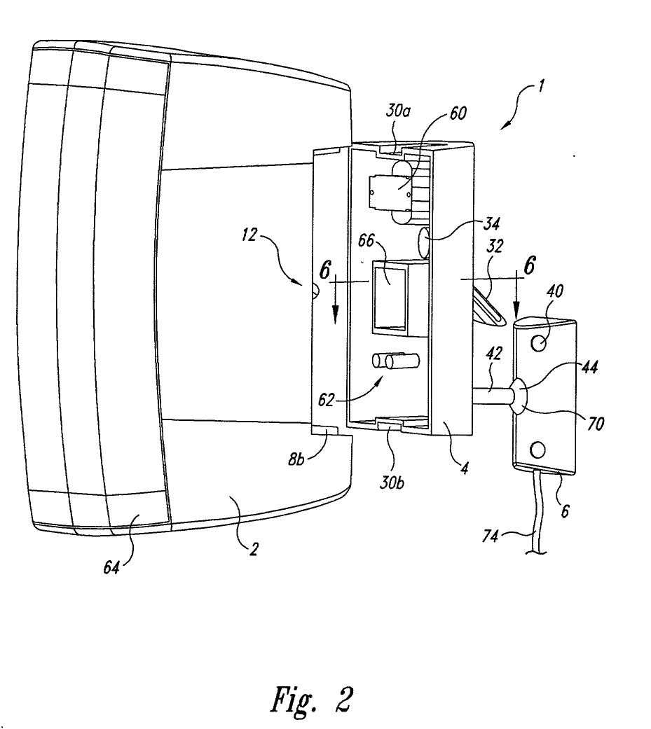

FIG. 1 is a rear isometric view illustrating a speaker mounting system 1 in accordance with one embodiment of the invention. FIG. 2 is a front isometric view of the speaker mounting system 1 of FIG. 1. The mounting system 1 of the illustrated embodiment includes a mounting plate 6 connected to a docking member 4, and a speaker housing 2 that releasably docks with the docking member 4 to securely hold the speaker housing 2 in a selected position and orientation. The mounting plate 6 is configured to be attachable to a structure (not shown), such as a wall or ceiling. In the illustrated embodiment, the mounting plate 6 has four mounting holes 40 through which fasteners (not shown) can be inserted to attach the mounting plate 6 to the structure. In alternative embodiments, the mounting holes 40 can be arranged differently and the mounting plate 6 can have a different number of mounting holes 40.

In the illustrated embodiment, the mounting plate 6 is pivotally and rotatably connected to the docking member 4 by a connector 42. The connector 42 of the illustrated embodiment is an elongated rod having an enlarged ball 70 on one end. The ball 70 is movably retained in a socket 72 formed in the mounting plate 6, thereby forming a ball and socket joint 44. The ball and socket joint 44 enables the connector 42 to pivot and rotate relative to the mounting plate 6. Accordingly, the ball and socket joint 44 is advantageous because it allows the speaker assembly 58 to be aimed. In alternative embodiments, the mounting plate 6 can have other types of joints, such as a fixed joint preventing the connector 42 from rotating or pivoting, or a hinge joint that allows pivoting. Moreover, in other embodiments, other connectors can be used. For example, one connector could mechanically support the docking member 4 and another connector could electrically connect the docking member 4 to the mounting plate 6. The connector 42, in the illustrated embodiment, is a hollow rod that provides a conduit through which speaker wires 74 are routed to connect to the docking member 4. In alternative embodiments, the connector 42 can have a channel or another configuration for receiving the speaker wire 74 extending to the docking member 4. In other embodiments, the speaker wire 74 can be routed to the docking member 4 in other ways, such as connecting directly to the docking member 4.

In the illustrated embodiment, the connector 42 is securely attached to the docking member 4 so that the docking member 4 is spaced apart from the mounting plate 6. The connector 42 is securely fixed to the docking member 4 by a nut 46 that connects to the docking member 4. The connector 42, thus, provides mechanical support to the docking member 4 and an electrical conduit between the mounting plate 6 and the docking member 4.

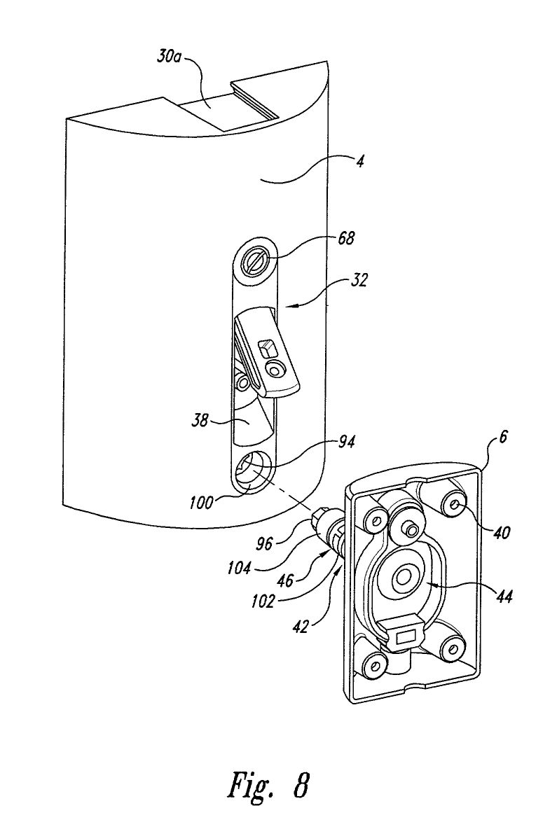

FIG. 8 is a rear isometric view of the connector 42 detached from the docking member 4. The nut 46 that connects the docking member 4 to the connector 42 is slidable along the axis of the connector 42 in the illustrated embodiment. In one embodiment, the nut 46 is retained on the connector 42 by a retaining ring (not shown) mounted on the connector 42. The outer surface of the nut 46 has a flat edge portion 102 and a threaded portion 104. The flat edge portion 102 of the nut 46 allows the nut 46 to be easily grasped by a tool for tightening. The threaded portion 104 of the nut 46 has threads on the outside surface so that the nut 46 forms the male portion of a male/female connection.

When the connector 42, in the illustrated embodiment, is connected to the docking member 4, the threaded portion 104 of the nut 46 screws into a threaded aperture 100 in the docking member 4. At the bottom of the threaded aperture 100 is a hexagonal aperture 94. As the threaded portion 104 of the nut 46 screws into the threaded aperture 100, a hexagonal end 96 of the connector 42 moves into the hexagonal aperture 94 of the docking member 4. Once the nut 46 is screwed into the threaded aperture 100 of the docking member 4, the placement of the hexagonal end 96 of the connector 42 in the hexagonal aperture 94 prevents the connector 42 from rotating relative to the docking member 4. Accordingly, the hexagonal configuration provides a key-way-type locking configuration. In alternative embodiments, other key-way-type configurations can be used, such as rectangular connectors, slotted connectors, and the like. One advantage of the illustrated embodiment is that the nut 46 allows the docking member 4 to easily and quickly detach from the mounting plate 6. Detachment might be desirable if, for example, a user wanted to place the speaker housing 2 on a bookshelf or other location where the mounting plate 6 is not needed. In alternative embodiments, the connector 42 can connect to the docking member 4 by other means. For example, the connector 42 can have a threaded end that screws into the aperture 100 of the docking member 4. Alternatively, the connector 42 could connect to a ball and socket joint in the docking member 4. Those of ordinary skill in the art will recognize other ways to attach the connector 42 to the docking member 4.

Referring to FIG. 1, in addition to the mounting plate 6 and the connector 42, the speaker mounting system 1 of the illustrated embodiment includes a speaker housing 2. The speaker housing 2 has a top surface 28, a bottom surface 27, and a curved side surface 23. The curved side surface 23 extends from one side of the speaker housing 2 around the back to the other side and includes a contour 22. In alternative embodiments, the speaker housing 2 can have side surfaces that are flat rather than curved. In the illustrated embodiment, the top surface 28 has a handle 24 to enable the speaker housing 2 to be carried more easily. Alternatively, the speaker housing 2 can have the handle 24 on another surface, or the speaker housing 2 might not have it at all.

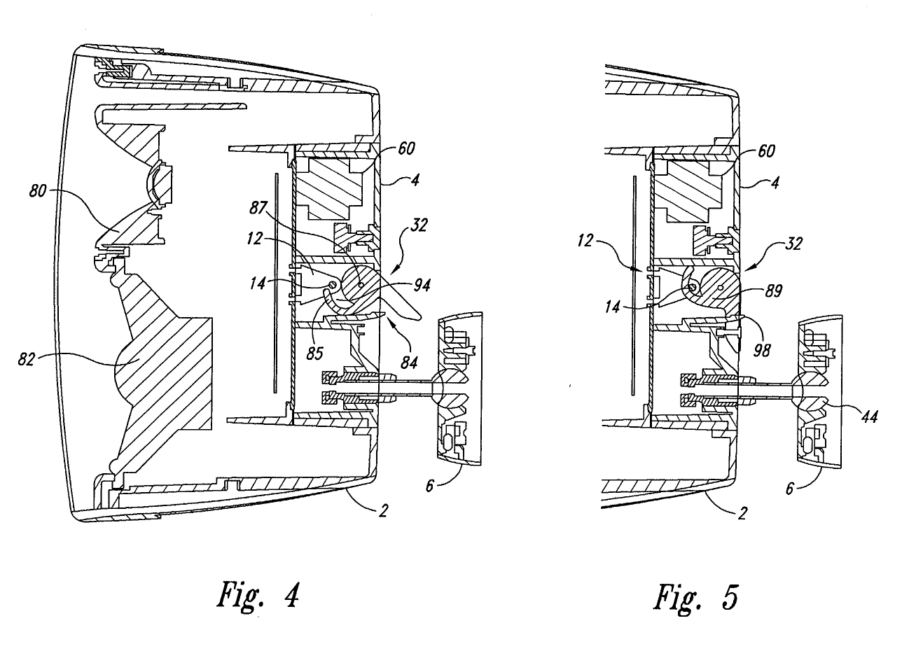

In the illustrated embodiment, the speaker housing 2 has a speaker cover 64 positioned adjacent to the top surface 28, the bottom surface 27, and the curved side surface 23. The speaker cover 64 can be made of metal (and have holes) or any other material that allows the sound from the speakers 80 and 82 (shown in FIG. 4) to pass through. Inside the speaker housing 2 is a small speaker 80 (such as a tweeter) and a large speaker 82 (such as a woofer). The small speaker 80 is positioned adjacent to the large speaker 82. In alternative embodiments, the speaker housing 2 can include any number of speakers, and speakers of any size. Furthermore, the speakers 80 and 82 can be arranged in a different manner.

The speaker housing 2 of the illustrated embodiment has a recess 17 in the curved side surface 23. A top surface 52, a bottom surface 54, and a back surface 15 form the recess 17. Attached to the top and bottom surfaces 52 and 54 are elongated projections 8a and 8b. The elongated projections 8a and 8b extend along the top and bottom surfaces 52 and 54 in a direction substantially transverse to the back surface 15. The projections 8a and 8b increase in width as they project a short distance from the top and bottom surfaces 52 and 54. In alternative embodiments, the top and bottom surfaces 52 and 54 can be flat (without projections), or they can have one or more grooves and/or projections. In other embodiments, the recess 17 might not include the top and bottom surfaces 52 and 54, but extend from the top surface 28 to the bottom surface 27 of the speaker housing 2. The back surface 15 of the recess 17 has a plate 16 fastened to the speaker housing 2 by fasteners 18. The plate 16 is removable to permit access inside the speaker housing 2. In alternative embodiments, the back surface 15 might not have a removable plate 16.

In FIG. 1, the docking member 4 is detached from the speaker housing 2. In the illustrated embodiment, the docking member 4 has a curved side surface 37, a top surface 48, and a bottom surface 50. The curved side surface 37 includes a contour 36. The top surface 48 has a groove 30a configured to slidably receive the projection 8a on the top surface 52 of the recess 17 in the speaker housing 2. Similarly, the bottom surface 80 has a groove 30b (FIG. 2) configured to slidably receive the projection 8b on the bottom surface 54 of the recess 17 in the speaker housing 2. The interface between the projections 8a and 8b and the corresponding grooves 30a and 30b provides for proper alignment of the docking member 4 and the speaker housing 2 as they are docked. In alternative embodiments, the speaker housing 2 can have grooves and the docking member 4 can have projections. In other embodiments, the docking member 4 and the speaker housing 2 might not have grooves or projections.

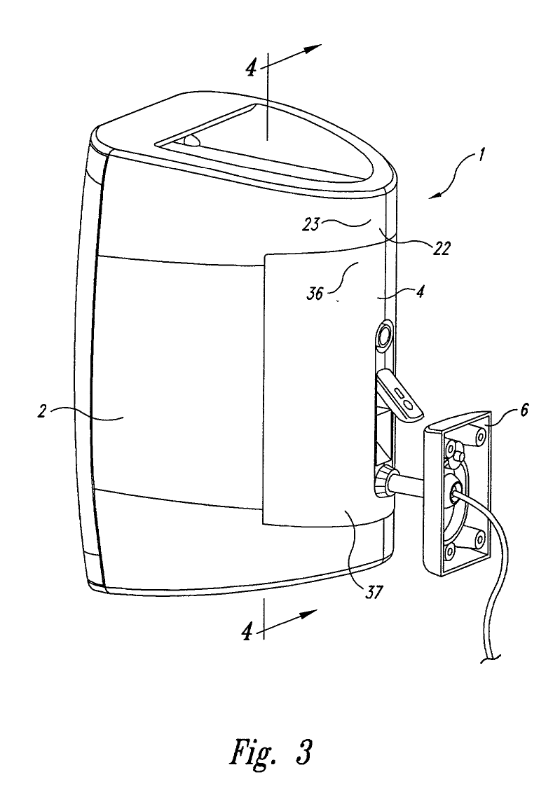

In the illustrated embodiment, the docking member 4 is configured to be slidably received in the recess 17 of the speaker housing 2. Docking occurs by aligning the projections 8a and 8b of the speaker housing 2 with the grooves 30a and 30b of the docking member 4 and then sliding the docking member 4 into the recess 17. FIG. 3 illustrates the speaker mounting system 1 in the docked position. In the docked position, the contour 36 on the curved side surface 37 of the docking member 4 substantially matches the contour 22 on the curved side surface 23 of the speaker housing 2 in the illustrated embodiment. The substantially matching contours 36 and 37 create an aesthetically smooth interconnection surface between the speaker housing 2 and the docking member 4. In alternative embodiments, the contours 36 and 37 might not match or create a smooth interconnection surface between the speaker housing 2 and the docking member 4.

When the speaker housing 2 is in the docked position, the docking member 4 connects to the speaker housing 2 by a quick connect mechanism. The quick connect mechanism permits a user to quickly connect the speaker housing 2 to the docking member 4. FIGS. 1-7 illustrate one embodiment of the quick connect mechanism including a catch 12 mounted to the speaker housing 2 and a latch 32 mounted to the docking member 4. Alternative embodiments can have other types of quick connect mechanisms, such as a socket fitting, detent mechanism, lock pin, spring pin, cam lock, quarter turn fastener, and the like. Referring to FIG. 1, the catch 12 is securely mounted to the plate 16 of the speaker housing 2 and positioned to be releasably engaged by the docking member 4. The catch 12 has a back plate 76, attached to the plate 16, a pair of spaced apart ears 78 extending from the back plate 76 and a crossbar 14 extending between the ears 78. In alternative embodiments, other configurations of the catch 12 can be used to provide a mechanical attachment point for the docking member 4. For example, the catch 12 could be a hole in the plate 16. In the illustrated embodiment, the latch 32 of the docking member 4 releasably engages the catch 12. As best seen in FIG. 4, the latch 32 of the illustrated embodiment has a cylindrical body 89, a handle 56 and a curved finger 85 attached to the cylindrical body 89. Between the curved finger 85 and the cylindrical body 89 is a slot 91. The latch 32 is secured to a latch housing 66 (shown in FIG. 2) by a pin 87. The pin 87 is placed in the center of the cylindrical body 89 so that the latch 32, including the curved finger 85, can rotate about the pin 87.

Referring to FIG. 4, the speaker housing 2 is docked on the docking member 4. In the illustrated embodiment, the latch 32 on the docking member 4 is in the open position, thus, the handle 56 of the latch 32 protrudes away from the docking member 4, and the crossbar 14 of the catch 12 is positioned outside of the slot 91 of the latch 32. With the latch 32 in the open position, the speaker housing 2 can be pulled off the docking member 4, or the latch 32 can be rotated to a closed position (shown in FIG. 5) by placing a downward force on the handle 56. As the latch 32 rotates about the pin 87 to a closed position, the curved finger 85 wraps around the crossbar 14 of the catch 12 and the crossbar 14 is received in the slot 91. In the closed position, the engagement of the crossbar 14 by the curved finger 85 locks the speaker housing 2 to the docking member 4. In the closed position the handle 56 of the latch 32 is received in an opening 38 (shown in FIG. 1) on the docking member 4.

In alternative embodiments, the docking member 4 can be selectively attached to the speaker housing 2 by other quick connect mechanisms. For example, the top and bottom of the speaker housing 2 can have holes with corresponding holes in the docking member 4. Pins can be selectively inserted into the holes to attach the docking member 4 to the speaker housing 2.

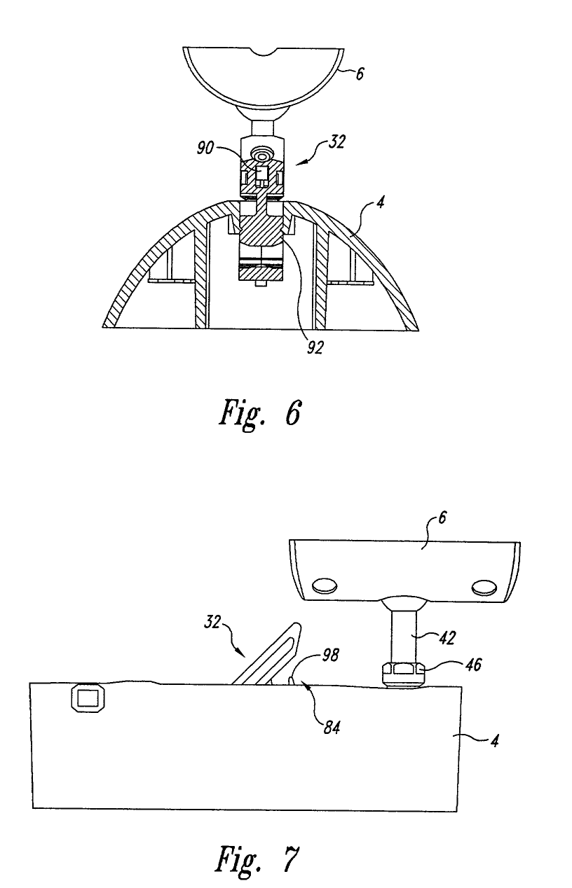

Referring to FIG. 6, the docking member 4 has a detent 92 to selectively retain the latch 32 in the open position in the illustrated embodiment. The detent 92 is an extension of the docking member 4 that contacts the cylindrical body 89 of the latch 32. The detent 92 is flexible so that it allows the latch 32 to close when a downward force is placed on the handle 56. Alternative embodiments might not have a detent or might have another device for selectively retaining the latch 32 in the open position.

Referring to FIGS. 4, 5, and 7, the docking member 4 has a locking mechanism 84 with a tip 98 for selectively locking the latch 32 in the closed position in the illustrated embodiment. When the latch 32 closes, the tip 98 of the locking mechanism 84 passes through an aperture 90 in the handle 56 of the latch 32. As the locking mechanism 84 passes through the aperture 90 it rubs against the latch 32 causing the locking mechanism 84 to flex so that the latch 32 can close. When the latch 32 is closed, the locking mechanism 84 flexes back and the tip 98 returns to its former position locking the latch 32 in the closed position. To open the latch 32, a user pushes the tip 98 of the locking mechanism 84 away from the latch 32, causing the locking mechanism 84 to flex. The user can then place a finger in the opening 38 and under the handle 56 of the latch 32 to rotate the latch 32 upward to the open position. In alternative embodiments, other devices for locking the latch 32 can be used, or the latch may not have a locking mechanism.

In FIG. 2, the speaker housing 2 is shown detached from the docking member 4. In the illustrated embodiment, the docking member 4 has a transformer 60 mounted above the latch 32. The transformer 60 has a transformer switch 34 with an adjustment dial or knob 68 (shown in FIG. 1). A user can adjust the adjustment knob 68 to vary the voltage provided to the speaker 82. Adjusting the voltage of the speaker 82 allows a user to individually select the volume of each speaker 82. This is particularly useful when it is desirable to have one speaker at a different volume than another speaker. For example, it might be desirable to have the speaker in a bar at a louder volume than the speaker in a bathroom. In alternative embodiments, the docking member 4 may not include the transformer 60.

In addition to the transformer 60, the docking member 4 of the illustrated embodiment has an electrical connector 62 positioned to electrically connect the docking member 4 to the components in the speaker housing 2. In the illustrated embodiment, the electrical connector 62 is a banana plug. In other embodiments, the electrical connector 62 can have a floating- or soft-spring mounting system to avoid fret corrosion. As best seen in FIG. 1, the electrical connector 62 is positioned to connect to an electrical connector 20 on the speaker housing 2. In the illustrated embodiment, the electrical connector 20 is a conventional five-way binding post. In alternative embodiments, other types of electrical connectors can be used to electrically connect the components in the speaker housing 2 to the docking member 4. In the illustrated embodiment, the electrical connectors 20 and 62 are axially aligned so that the banana plug will slide into and electrically engage the five-way binding post when the speaker housing 2 docks with the docking member 4. When the speaker housing 2 is docked with the docking member 4 the electrical components are electrically coupled together. In the illustrated embodiment, the speaker wire 74 passes through the connector 42 and is electrically connected to the transformer 60 and transformer switch 34. The transformer 60 and transformer switch 34 are electrically connected to the electrical connector 62 on the docking member 4, which is electrically connected to the electrical connector 20 on the speaker housing 2. The electrical connector 20 is electrically connected to the components in the speaker housing 2. In alternative embodiments, if the docking member 4 does not include a transformer 60 the speaker wire 74 can be electrically connected to the electrical connector 62.

One advantage of the illustrated embodiment of the invention is that the mounting plate 6 can be attached to a structure before it is painted, thereby decreasing the possibility of scuffing or scraping the newly painted structure during the installation. Furthermore, the mounting plate 6 can be attached and wired to the structure without supporting the weight of the speaker 82 or speaker housing 2. Another advantage of the illustrated embodiment is that the speaker housing 2 can be installed quickly after the mounting plate 6 has been connected to the structure and the docking member 4 has been attached to the mounting plate 6. Accordingly, the speaker housing 2 can be docked to the docking member 4 simply by sliding the speaker housing 2 onto the docking member 4 and actuating the quick connect mechanism.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A speaker mounting system for attaching a speaker to a structure, comprising:
a mounting member attachable to the structure;
a docking member coupled to the mounting member; and
a speaker housing releasably attached to the docking member, the speaker housing having a side with a receiving portion that removably receives the docking member.

2. The system of claim 1 wherein the speaker housing is releasably attached to the docking member by a quick connect mechanism movable between a first position and a second position.

3. The system of claim 1, further comprising:
a catch on the speaker housing; and
a latch on the docking member, wherein the latch releasably engages the catch.

4. The system of claim 3 wherein the latch is movable between an open position and a closed position, and the docking member includes a detent mechanism that releasably retains the latch in at least one of the open and closed positions.

5. The system of claim 1, further comprising:
a latch on the docking member movable between an open position and a closed position; and
a lock on the docking member releasably engaging the latch in the closed position.

6. The system of claim 1, further comprising a connector attached to the mounting member and the docking member, wherein the mounting member is connected to the connector by a ball and socket joint.

7. The system of claim 1 wherein the docking member includes a transformer, the transformer being electrically connected to the speaker housing when the docking member is attached to the speaker housing.

8. The system of claim 1 wherein one of the speaker housing and the docking member includes a groove and the other of the speaker housing and the docking member includes a projection configured to be slidably received within the groove.

9. The system of claim 8 wherein the docking member and the speaker housing are slidably attached.

10. The system of claim 1 wherein the receiving portion is a receptacle.

11. An apparatus for mounting a speaker to a structure, the apparatus comprising:
a mounting member mountable to the structure;
a first connector attached to the mounting member;
a docking member attached to the first connector, the docking member having a second connector and an electrical connector; and
a speaker housing having a connection portion removably engaged by the second connector and having at least one electrical connection that releasably engages the electrical connector to operatively connect the speaker housing to the docking member, the speaker housing having a side with a receiving portion, the mounting member being positionable in the receiving portion.

12. The apparatus of claim 11 wherein the second connector includes a quick connect mechanism.

13. The apparatus of claim 11 wherein the second connector includes a quick connect mechanism moveable between a first and a second position.

14. The apparatus of claim 11 wherein the second connector includes a latch releasably engaging the connection portion on the speaker housing.

15. The apparatus of claim 14 wherein the latch is movable between an open position and a closed position, and the docking member includes a detent mechanism that releasably retains the latch in at least one of the open and closed positions.

16. The apparatus of claim 11 wherein the second connector includes a latch movable between an open position and a closed position, and the docking member includes a lock releasably engaging the latch in the closed position.

17. The apparatus of claim 11 wherein the connection portion is a catch releasably engaged by the second connector.

18. The apparatus of claim 11 wherein the docking member includes a transformer, the transformer being electrically coupleable to the speaker housing.

19. The apparatus of claim 11 wherein one of the speaker housing and the docking member includes at least one groove and the other of the speaker housing and the docking member includes at least one projection configured to be slidably received within the at least one groove.

20. A speaker mounting apparatus, comprising:
a mounting bracket;
a docking member coupled to the mounting bracket, the docking member having a latch and an electrical connector; and
a speaker releasably connected to the docking member, the speaker having a catch releasably engaged by the latch to connect the speaker to the docking member, the electrical connector electrically connecting the docking member to the speaker.

21. The apparatus of claim 20 wherein the docking member includes a transformer operatively coupled to the speaker.

22. The apparatus of claim 20 wherein one of the speaker and the docking member includes at least one groove and the other of the speaker and the docking member includes at least one projection configured to be slidably received within the at least one groove.

23. The apparatus of claim 20 wherein the latch is movable between an open position and a closed position, and the docking member includes a detent mechanism that releasably retains the latch in one of the open position and the closed position.

24. The apparatus of claim 20 wherein the docking member includes a lock releasably engaging the latch in the closed position.

25. The apparatus of claim 20, further comprising:
a first connector connecting the mounting bracket and the docking member; and
speaker wire extending through the first connector, the speaker wire electrically connected to the electrical connector.

26. The apparatus of claim 20 wherein the latch is movable between a first position and a second position.

27. A method for attaching a speaker housing to a structure, the method comprising:
mounting a mounting bracket to the structure;
connecting a docking member to the mounting bracket using a connector;
removably attaching a speaker housing to the docking member by a retention member; and
aiming the docking member and the speaker housing as a unit relative to the mounting bracket and the structure.

28. The method of claim 27 wherein removably attaching a speaker housing to the docking member by a retention member includes removably attaching a speaker housing to the docking member by a quick release mechanism.

29. The method of claim 27 wherein aiming the docking member and the speaker housing includes moving a ball in a ball and socket joint adjacent to the mounting bracket.

30. The method of claim 27 wherein removably attaching a speaker housing to the docking member includes removably engaging a catch on the speaker with a latch on the docking member.

31. The method of claim 27 wherein removably attaching a speaker housing to the docking member includes removably electrically connecting a transformer in the docking member to the speaker housing.

32. The method of claim 27 wherein removably attaching a speaker housing to the docking member includes sliding at least one projection on the speaker housing into a groove in the docking member.

33. The method of claim 27 wherein removably attaching a speaker housing to the docking member includes sliding at least one projection on the docking member into a groove in the speaker housing.

34. The method of claim 27, further comprising:
running speaker wire through the connector; and
connecting the speaker wire to the docking member.

35. The method of claim 27, further comprising removably attaching a first electrical connector on the docking member to a second electrical connector on the speaker housing.
